(19) United States
(12) Patent Application Publication
(10) Pub. No.: US 2011/0176879 A1
(43) Pub. Date: Jul. 21, 2011

(54) SUPERHARD BODY, TOOL AND METHOD FOR MAKING SAME

(76) Inventors: Cornelis Roelof Jonker, Olympus (ZA); Maweja Kasonde, East Rand (ZA)

(21) Appl. No.: 13/009,346

(22) Filed: Jan. 19, 2011

Related U.S. Application Data
(60) Provisional application No. 61/296,836, filed on Jan. 20, 2010.

(51) Int. Cl. B23B 51/02; B32B 37/14

(52) U.S. Cl. 408/144; 156/60; 156/293; 156/306.6

(57) ABSTRACT

A method for making a superhard tip for a rotary machine tool, the method including contacting at least one sintered polycrystalline superhard structure to a carrier body comprising cemented carbide to form a pre-compact assembly, and subjecting the pre-compact assembly to a pressure and temperature at which the superhard material is thermodynamically stable to form a pre-form body for a superhard tip; and processing the pre-form body to form a superhard tip.

This application claims the benefit of U.S. Provisional Application No. 61/296,836 filed Jan. 20, 2010, the disclosure of which is incorporated herein by reference in its entirety.

### BACKGROUND

Embodiments of the invention relate generally to a method for making superhard bodies and superhard tips for rotary machine tools, in particular but not exclusively for twist drills or end mills; to superhard tips thus made and tools comprising same.

Examples of a superhard material are polycrystalline diamond (PCD) material and polycrystalline cubic boron nitride (PCBN) material. PCD material comprises a mass of substantially inter-grown diamond grains and PCBN material comprises cubic boron nitride (cBN) particles within a matrix comprising metal and/or ceramic material. PCD and PCBN may be made by subjecting aggregated masses of diamond grains or cBN grains, respectively, to an ultra-high pressure of at least about 5.5 GPa and temperature of at least about 1,250 degrees centigrade.

A rotary machine tool is a machine tool such as a drill, comprising a cutter element that rotates.

United States patent application publication number 2008/0247899 discloses a helical shaped solid PCD and PCBN tip that can be attached to the conventional tool substrates such as twist drills, drills, and end mills.

There is a need to provide a method of making improved superhard-tipped rotary machine tools.

### SUMMARY

Viewed from a first aspect, a method for making a superhard tip for a rotary machine tool can be provided, the method including contacting at least one sintered (i.e. pre-sintered) polycrystalline superhard structure, such as a PCD structure, to a carrier body comprising cemented carbide, or to a precursor structure for the carrier body, to form a pre-compact assembly, and subjecting the pre-compact assembly to a pressure and temperature at which the superhard material is thermodynamically stable to form a superhard tip or a pre-form body for a superhard tip for a rotary machine tool. The pre-form body may be processed to form the superhard tip for a rotary machine tool, such as a twist drill or end mill.

The sintered polycrystalline superhard structure comprises polycrystalline superhard material made by a method including sintering a plurality of superhard particles at an ultra-high pressure of at least about 2 GPa.

Viewed from a second aspect, a pre-form for a superhard tip and/or a superhard tip can be provided.

Viewed from a third aspect, a component for a rotary machine tool and/or a rotary machine tool can be provided.

### BRIEF INTRODUCTION TO THE DRAWINGS

Non-limiting example arrangements to illustrate the present disclosure are described with reference to the accompanying drawings, of which,

FIG. 1 shows a schematic perspective view of an example pre-form body for a superhard tip.

FIG. 2A shows a schematic perspective view of an example pre-compact assembly, in the assembled state.

FIG. 2B shows a schematic perspective view of an example assembled pre-compact, in an unassembled state.

FIG. 3 shows a schematic side view of an example carrier body.

FIG. 4 shows a schematic perspective view of an example superhard tip for a twist drill.

FIG. 5 shows a schematic side view of an example twist drill.

FIG. 6A shows a schematic perspective view of part of an example carrier body.

FIG. 6B shows a schematic perspective view of part of the example carrier body of FIG. 6B, and a longitudinal plane through the carrier body.

FIG. 6C shows a schematic perspective view of an example pre-compact assembly, in the assembled state.

The same references refer to the same general features in all of the drawings.

### DETAILED DESCRIPTION

Certain terms as used herein are explained below.

A superhard or ultra-hard material is understood to mean a material having Vickers hardness of at least 25 GPa. The term “polycrystalline superhard structure” means a structure comprising a sintered mass of superhard grains.

Synthetic and natural diamond, polycrystalline diamond (PCD), cubic boron nitride (cBN) and polycrystalline cBN (PCBN) material are examples of superhard materials. Synthetic diamond, which is also called man-made diamond, is diamond material that has been manufactured. Polycrystalline diamond (PCD) material comprises a mass (an aggregation of a plurality) of diamond grains, a substantial portion of which are directly inter-bonded with each other and in which the content of diamond is at least about 80 volume percent of the material. Interstices between the diamond grains may be at least partly filled with a binder material comprising a catalyst material for synthetic diamond, or they may be substantially empty. A catalyst material for synthetic diamond is capable of promoting the growth of synthetic diamond grains and or the direct inter-growth of synthetic or natural diamond grains at a temperature and pressure at which synthetic or natural diamond is thermodynamically stable. Examples of catalyst materials for diamond are Fe, Ni, Co and Mn, and certain alloys including these. Bodies comprising PCD material may comprise at least a region from which catalyst material has been removed from the interstices, leaving interstitial voids between the diamond grains. PCBN material comprises grains of cubic boron nitride (cBN) dispersed within a matrix comprising metal or ceramic material.

A machine tool is a powered mechanical device, which may be used to manufacture components comprising materials such as metal, composite materials, wood or polymers by machining. Machining is the selective removal of material from a body or a workpiece, particularly in an industrial manufacturing context. A rotary machine tool comprises a cutter element, for example a drill bit, and rotates about its own axis in use. A tipped tool or insert is one in which the cutting edge is formed by a cutter element comprised of a different material from that of the rest of the tool or insert, the cutter element typically being brazed or clamped on to a body. A tip for a machine tool may be produced by processing a pre-form body to form it into a configuration for a tip. A rake face of a machine tool is the surface or surfaces over which the chips flow when the tool is used to remove material from a body, the rake face directing the flow of newly formed chips. Chips are the pieces of a body removed from the work surface of the body by a machine tool in use. A cutting edge of a tip or tool is the edge of a rake face intended to perform cutting of a body.

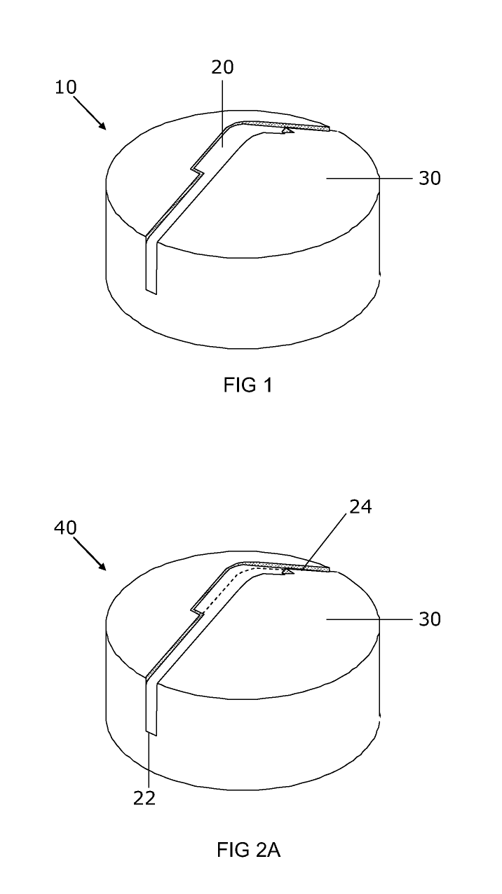

Examples of a method for making superhard tips for rotary machine tools will now be described with reference to FIG. 1 to FIG. 6C.

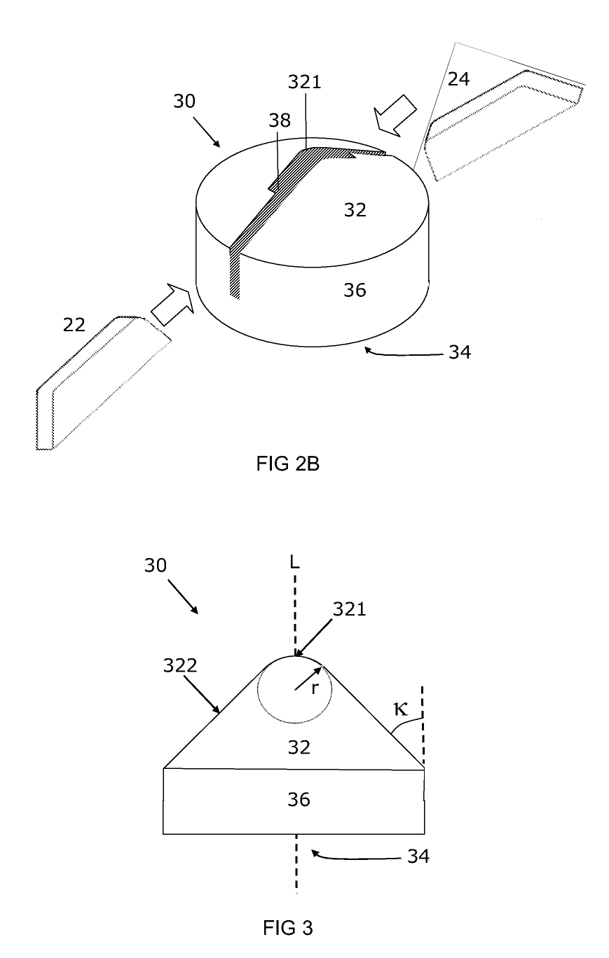

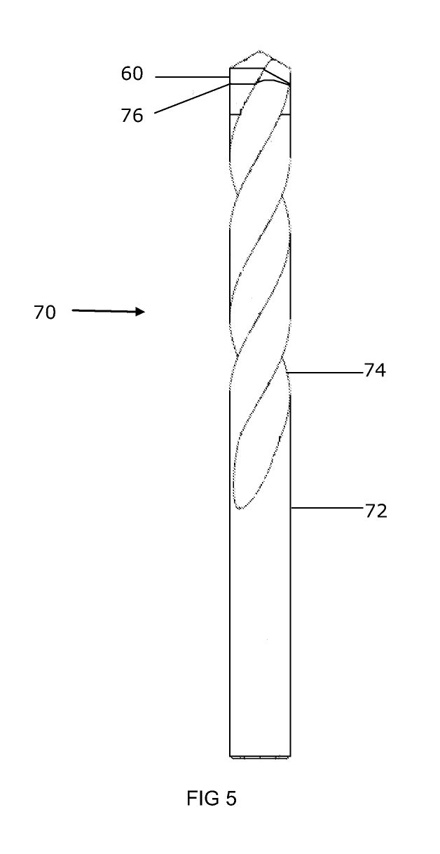

In an example illustrated in FIG. 1, a pre-form body 10 for making a superhard tip comprises a superhard structure 20 and a carrier body 30. An example of a superhard tip 60 for a twist drill is illustrated in FIG. 4. With reference to FIG. 2A and FIG. 2B, a pre-form body 10 can be made by a method including contacting at least one sintered polycrystalline superhard structure 22, 24 (also referred to herein for brevity as a superhard structure) comprising superhard material, to a carrier body 30 comprising cemented carbide material (or comprising a precursor structure for a carrier body) to form a pre-compact assembly 40, and subjecting the pre-compact assembly 40 to a pressure and temperature at which the superhard material is thermodynamically stable, to form a pre-form body 10. The ultra-high pressure may be at least about 2 GPa.

The superhard structure or structures 22, 24 on the one hand and the carrier body 30 or precursor structure for the carrier body 30 on the other are each provided pre-formed in complementary configurations. The superhard structure(s) 22, 24, which comprises a superhard material such as PCD or PCBN material, is provided as a pre-sintered structure(s). In other words, the structure has already been made by sintering superhard material at an ultra-high pressure of at least about 5 GPa and a temperature of at least about 1,250 degrees centigrade to produce a superhard body, and forming a structure configured as desired and for accommodation in the carrier body 30 (or precursor structure for the carrier body 30).

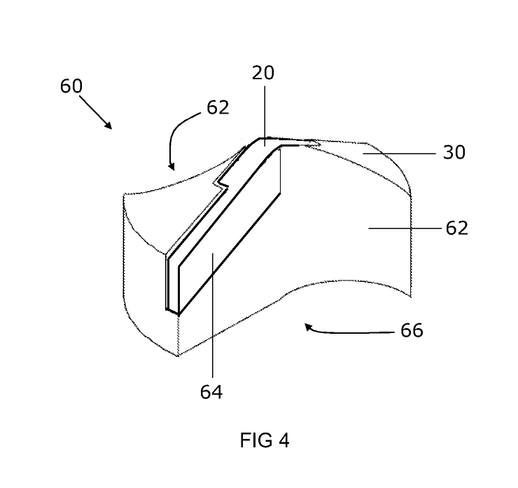

With reference to FIG. 3, an example of a carrier body 30 for a pre-compact assembly 40 for a drill bit (not shown), comprises tungsten carbide particles and cobalt metal for cementing the particles, and has a blunted conical shaped working end 32 with a generally rounded or spherically rounded apex 321 having a radius of curvature r, an attachment end 34 for joining the superhard tip to a tool, and may have a generally cylindrical side surface 36 between the ends 32 and 34. The working end 32 has a working surface 322 disposed at a cone angle K relative to an axis aligned with central longitudinal axis L.

The carrier body 30 may comprise pre-sintered cemented carbide or unsintered precursor material for making cemented carbide. The carrier body (or precursor for the carrier body) is provided configured for accommodating the superhard structure(s) 22, 24 as illustrated in FIG. 2B. For example, the carrier body 30 may be provided with a recess 38 formed at the working end 32 into which superhard structure(s) 22, 24 may be slotted. In the present example, the recess 38 may pass generally diametrically through the apex 321 of the carrier body 30 and be configured to receive and accommodate a corresponding pair of pre-sintered superhard structure(s) 22, 24, which are inserted into the recess 38 to form a pre-compact 40. In this particular example, the recess 38 and the superhard structure(s) 22, 24 are configured so that the superhard structure(s) 22, 24 overlap and contact each other at the apex 321 of the carrier body 30. In one version, the recess 38 may be configured to accommodate the polycrystalline superhard structure(s) 22, 24 with an interference fit.

Better results may be achieved if the superhard structure(s) 22, 24 and at least the part of the carrier body 30 comprising the recess 38 are washed in an acidic or alkaline solution prior to assembly.

In one version of the method, a bonding agent may be provided adjacent a surface of the recess, between the superhard structure(s) and the carrier body, the bonding agent being capable of bonding with the polycrystalline superhard structure.

Once assembled as illustrated in FIG. 2A, the pre-compact 40 may then placed into a capsule (not shown) suitable for use in an ultra-high temperature furnace or press, and subjected to pressure of at least about 2 GPa and a sufficiently high temperature to form a unitary body 10 as illustrated in FIG. 1, which may serve as a pre-form body for a superhard tip. In one example, the pressure may be at least about 5.5 GPa and the temperature at least about 1,300 degrees centigrade and the superhard structure(s) 22, 24 may be directly sintered to each other in the pre-form body 10. In some versions of the method, the pressure may be at least 2 GPa or at least 5.5 GPa; and in some versions, the temperature may be at least about 1,200 degrees centigrade, at least 1,300 degrees centigrade or at least 1,400 degrees centigrade.

As used herein, a twist drill bit is a fluted tipped drill bit for use in drilling holes into workpieces, particularly workpieces comprising metals, wood and plastics, by means of a rotational shear cutting action. A twist drill is typically held in a chuck, collet or other mechanical coupling device which is mounted on a precision spindle. It is rotated about its own axis of rotation and may be linearly translated such that the drill advances through a workpiece, expelling the waste metal in the form of chips or swarf. The twist drill may comprise elements which enable it to cut and evacuate the waste metal. A working end of the drill contains the cutting edges, usually extending parallel to the diameter, each extending from a central chisel edge. The flutes may have the form of grooves that appear generally semi-circular in cross section. While some drills contain straight flutes, extending parallel to the axis of the tool, most twist drills comprise helical flutes, the helix angle determining not only the rake angle of the cutting edge but also the ease of chip evacuation and the stiffness of the drill.

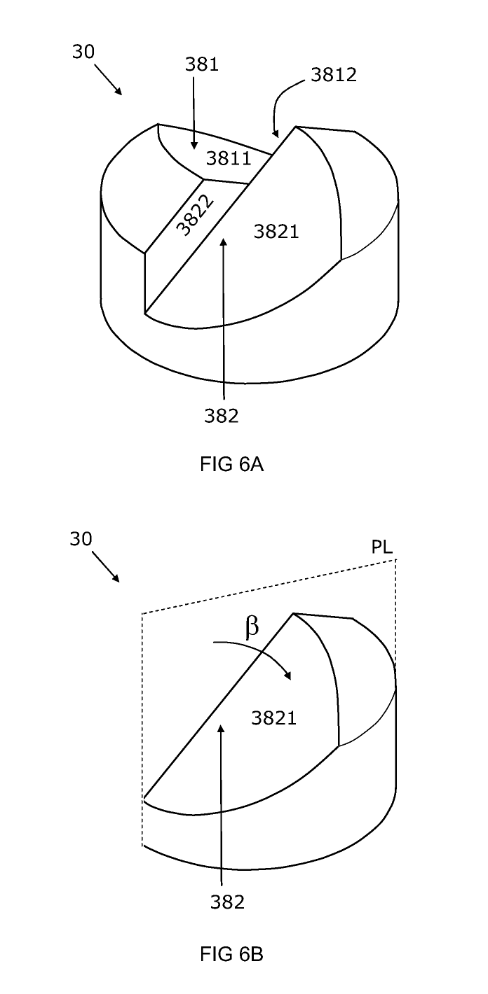

As illustrated in FIG. 4, a superhard tip 60 for a twist drill bit, an example of which is illustrated in FIG. 5, may then be formed by processing the tip pre-form 10. The example twist drill bit 70 may comprise a drill shaft 72 having a flute 74, and a superhard tip 60 joined to an end 76 of the drill shaft 72. In particular, carbide material may be removed from the tool carrier portion 30 of the tip pre-form 10 to form flutes 62 into the superhard tip 60 corresponding to the fluting 74 of the drill shaft 70 to which it will be joined.

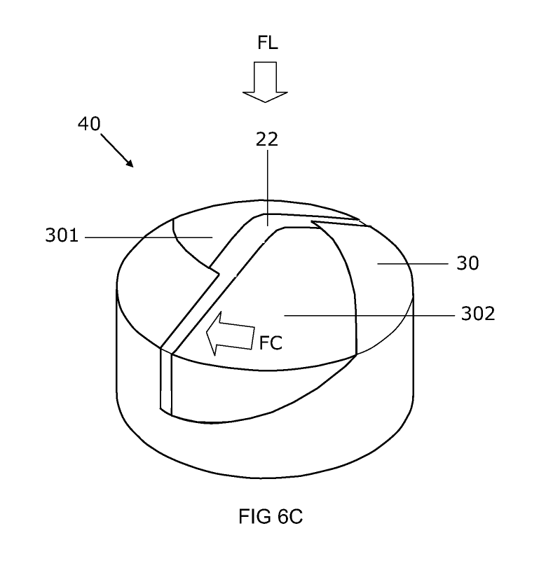

In one example with reference to FIG. 6A to FIG. 6C, a carrier body 30 is provided with recesses 381 and 382 formed into the working end 32. Recess 381 has side surfaces 3811 and 3812, and recess 382 has side surfaces 3821 and 3822. Each side surface 3811 and 3821 is inclined at an angle β to a longitudinal plane PL, and each recess 381 and 382 is configured to receive respective superhard structures 22 and 24 and respective buttress members 301 and 302. The recesses 381 and 382 and the buttress members 301 and 302 are co-operatively configured for assembly into a pre-compact assembly 40. Each of the buttress members 301 and 302 is disposed between and contacts respective superhard structures 22 and 24 and respective inclined side surfaces 3811 and 3821. Each superhard structure 22 and 24 is thus “sandwiched” between respective buttress members 301 and 302 and respective side surfaces 3812 and 3822. In the present example, the inclined side surfaces 3811 and 3821 are configured operable to deflect the respective buttress members (laterally or circumferentially) against the respective polycrystalline superhard structure 22 and 24 with respective lateral or circumferential force FC, responsive to applying a longitudinal force FL to the respective buttress members 301 and 302. Thus the buttress members 301 and 302 may enhance the lateral or circumferential force on the superhard structure(s) 22, 24 during the treatment of the pre-compact assembly 40 at the ultra-high pressure, in which the principal force FL may be applied longitudinally. The buttress members 301 and 302 may be removed from the pre-form body after the treatment that ultra-high pressure.

In order make it easier to separate the buttress members 301 and 302 from the drill tip pre-form after treatment at ultra-high pressure, substantially non-reactive foil or paper, which may comprise alumina for example, may be placed between the buttress members 301 and 302 and the superhard structure(s) 22, 24 on the one hand and the carrier body surfaces 3811, 3812, 3821 and 3822 on the other, in the pre-compact assembly. An alumina foil may be made by casting a slurry containing fine particles of Al₂O₃, having mean particle size of at most about 100 microns. The thickness of the foil may be at least about 50 microns and at most about 1,000 microns, and in one example, the thickness of the foil is about 500 microns. After the pre-compact assembly has been treated at ultra-high pressure, the substantially non-reactive foil may have the aspect that the buttress members 301, 302 may more easily be detached by means sand blasting, for example.

In one example, the superhard tip may have an elongate or generally cylindrical form having a proximate and a distal end, the proximate end being a working end and the distal end being an attachment end, a side surface connecting the proximate and distal ends; at east part of the working end having a substantially conical, frusto-conical shape or rounded conical shape, for example a spherically rounded conical shape; the superhard structure being disposed adjacent the working end. In one embodiment, at least one recess may be formed into carrier body from the working end and accommodate at least one superhard structure. In one embodiment, the recess may be a slot formed with a pair of substantially parallel flat surfaces, for accommodating a polycrystalline superhard structure in generally wafer or layer form. The polycrystalline superhard structure may have the general form of a tongue operable to be inserted into a slot at the working end.

In one example, the superhard structure may comprise PCD material, and in one variant, the superhard structure may comprise a thermally stable PCD structure. As used herein, the thermally stable PCD structure comprises PCD material, in which at least a region or even the entire volume of the PCD structure is substantially free of active solvent/catalyst material for diamond. One way of achieving this is to remove solvent/catalyst material from interstices within the PCD material by means of acid leaching. In one embodiment, the PCD structure may be substantially free of material capable of functioning as solvent/catalyst for diamond. In some embodiments, there may be less than about 5 volume percent or even less than about 2 volume percent of solvent/catalyst for diamond in the PCD structure. In some embodiments, the PCD structure may be at least partially porous, or substantially the entire PCD structure may be porous.

As used herein, a PCD grade is a PCD material characterised in terms of features such as the volume content and size of diamond grains, the volume content of interstitial regions between the diamond grains and composition of material that may be present within the interstitial regions. Different PCD grades may have different microstructure and different mechanical properties, such as elastic (or Young's) modulus E, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

In some examples, the PCD material may have Young's modulus of at least about 850 GPa, and in some embodiments, the PCD structure may have a transverse rupture strength of at least about 1,000 MPa, or even at least about 1,100 MPa. In some examples, the PCD structure may comprise at least about 90 volume percent inter-bonded diamond grains having a mean size in the range from about 0.1 microns to 25 microns, or even in the range from about 0.1 micron to about 10 microns. In one embodiment of the invention, the PCD structure may comprise diamond grains having a multi-modal size distribution. In some embodiments, the PCD structure may comprise bonded diamond grains having the size distribution characteristic that at least about 50 percent of the grains have mean size greater than about 5 microns, and at least about 20 percent of the grains have mean size in the range from about 10 to about 15 microns.

The size of grains or interstitials between grains is expressed in terms of equivalent circle diameter (ECD). As used herein, the “equivalent circle diameter” (ECD) of a particle is the diameter of a circle having the same area as a cross section through the particle. The ECD size distribution and mean size of a plurality of particles may be measured for individual, unbonded particles or for particles bonded together within a body, by means of image analysis of a cross-section through or a surface of the body.

In some embodiments, the interstitial mean free path between adjacent diamond grains comprised in the PCD material may be at least about 0.05 microns and at most about 1.5 microns; the standard deviation of the mean free path being at least about 0.05 microns and at most about 1.5 microns. As used herein, the “interstitial mean free path” within a polycrystalline material comprising an internal structure including interstices or interstitial regions, such as PCD, is understood to mean the average distance across each interstitial between different points at the interstitial periphery. The mean free path is determined by averaging the lengths of many lines drawn on a micrograph of a polished sample cross section. The mean free path standard deviation is the standard deviation of these values. The diamond mean free path is defined and measured analogously.

The homogeneity of the microstructure may be characterised in terms of the combination of the mean thickness of the interstices between the diamonds, and the standard deviation of this thickness. The homogeneity or uniformity of PCD material may be quantified by conducting a statistical evaluation using a large number of micrographs of polished sections. The distribution of a filler phase or of pores within the PCD structure may be easily distinguishable from that of the diamond phase using electron microscopy and can be measured in a method similar to that disclosed in EP 0 974 566 (see also WO2007/110770). This method allows a statistical evaluation of the average thicknesses or interstices along several arbitrarily drawn lines through the microstructure. The mean binder or interstitial thickness is also referred to as the “mean free path”. For two materials of similar overall composition or binder content and average diamond grain size, the material that has the smaller average thickness will tend to be more homogenous, as this indicates a finer scale distribution of the binder in the diamond phase. In addition, the smaller the standard deviation of this measurement, the more homogenous the structure is likely to be. A large standard deviation indicates that the binder thickness varies more widely and that the structure is less uniform.

In measuring the mean value and deviation of a quantity such as grain size, grain contiguity or interstitial mean free path, several images of different parts of a surface or section are used to enhance the reliability and accuracy of the statistics. The number of images used to measure a given quantity or parameter may be at least about 9 or even up to about 36. The resolution of the images needs to be sufficiently high for the inter-grain and inter-phase boundaries to be seen. In the statistical analysis, typically 16 images are taken of different areas on a surface of a body comprising the PCD material, and statistical analyses are carried out on each image as well as across the images. Each image should contain at least about 30 diamond grains, although more grains may permit more reliable and accurate statistical image analysis.

In some embodiments, the PCD structure may be as taught in PCT publication number WO2007/020518, which discloses polycrystalline diamond a polycrystalline diamond abrasive element comprising a fine grained polycrystalline diamond material characterised in that it has an interstitial mean-free-path value of less than 0.60 microns, and a standard deviation for the interstitial mean-free-path that is less than 0.90 microns. In one embodiment, the polycrystalline diamond material may have a mean diamond grain size of from about 0.1 to about 10.5.

One method for making a superhard structure comprising PCD material includes sintering together diamond grains in the presence of a catalyst (also called “solvent/catalyst”) material for synthetic diamond, for example cobalt, at a pressure and temperature at which the diamond is thermodynamically more stable than graphite, such as a pressure of at least about 5 GPa and a temperature of at least about 1,250 degrees centigrade. In some versions, the pressure may be greater than 6.0 GPa or even least about 8 GPa.

When sintering an aggregated mass of diamond grains together to form PCD material, solvent/catalyst material may be introduced to the aggregated mass in various ways. One way includes depositing metal oxide onto the surfaces of a plurality of diamond grains by means of precipitation from an aqueous solution prior to forming their consolidation into an aggregated mass. Such methods are disclosed in PCT publications numbers WO2006/032984 and also WO2007/110770. Another way includes preparing or providing metal alloy including a catalyst material for diamond in powder form and blending the powder with the plurality of diamond grains prior to their consolidation into an aggregated mass. The blending may be carried out by means of a ball mill. Other additives may be blended into the aggregated mass. The aggregated mass of diamond grains, including any solvent/catalyst material particles or additive material particles that may have been introduced, may be formed into an unbonded or loosely bonded structure, which may be placed onto a cemented carbide substrate. The cemented carbide substrate may contain a source of catalyst material for diamond, such as cobalt. The assembly comprising the aggregated mass of grains and the substrate may be encapsulated in a capsule suitable for an ultra-high pressure furnace apparatus and subjecting the capsule to a pressure of greater than 6 GPa.

Various kinds of ultra-high pressure apparatus are known and can be used, including belt, torroidal, cubic and tetragonal multi-anvil systems. The temperature of the capsule should be high enough for the catalyst material to melt and low enough to avoid substantial conversion of diamond to graphite. The time should be long enough for sintering to be completed but as short as possible to maximise productivity and reduce costs.

Superhard PCD structure or structures may be made from a PCD composite compact comprising a PCD structure bonded to a cemented carbide substrate, which may be provided as described above. The PCD composite compact may have a generally disc shape, for example. In one example, the cemented carbide substrate may be removed by grinding it away, leaving substantially only a self-supporting PCD body, from which the PCD structure may be cut using, for example, electro-discharge machining (EDM). The EDM cutting method involves generating an electrical discharge between an EDM wire and the PCD body to degrade the PCD body locally. The EDM wire may be guided through the PCD body according to the desired shape of the PCD structure. The EDM wire may comprise an alloy including copper (Cu) and zinc (Zn) and/or other metal, and the EDM cutting process may result in some metal from the EDM wire being deposited on the cut surface of the PCD structure. Similarly, in examples where a recess is cut into a cemented carbide carrier body by means of EDM, some metal from the EDM wire may be deposited onto cut surfaces of the carrier body.

Better results are expected to be achieved if at least the cut surfaces of the PCD structure or structures and the carrier body are cleaned before assembly to form a pre-compact assembly. In one example, the PCD structures and the cemented carbide carrier body may be cleaned by immersion in a dilute solution of nitric acid or hydrochloric acid, having pH value of at least about 1 and at most about 3, in an ultrasonic bath for about 20 to 30 minutes. In another example, the PCD structures and/or the carrier body may be immersed in an ammonia solution having a pH value of at least about 13. An example acid cleaning reaction may be schematised as follows: xCu+yZn+2(x+y)HNO₃=xCu⁽²⁺⁾+yZn⁽²⁺⁾+(x+y)H₂+2(x+y)NO₃⁽⁻⁾. An example ammonia cleaning reaction may be schematised as follows: xCu+yZn+z(x+y)NH₄OH=x[Cu[NH₃]z]⁽²⁺⁾+y[Zn[NH₃]z]⁽²⁺⁾+z(x+y)H₂O. In both cases, x and y are the atomic ratios of Cu and Zn, and z values are 2 or 4. After treatment in an acid or alkali solution, the PCD structure and carrier body may be washed in water and ethanol to remove adsorbed salt solutions, and then dried.

In versions of the method in which a PCD body is provided bonded to a cemented carbide substrate, the process of forming a PCD structure for use with the carrier body may include removing at least part of the substrate by grinding it away, as mentioned previously. In such versions, the PCD structure may be manufactured using one grade of cemented carbide and then combined with a different grade in the pre-compact assembly. This has the aspect that the superhard tip may comprise a grade of PCD material that may be difficult to form directly on the type or grade of carbide comprised in the carrier body. For example, in embodiments where the polycrystalline superhard structure comprises PCD material and the carrier body comprises cobalt cemented carbide, the cobalt content of a carrier body may be lower than would be preferred for sintering the PCD in a single step. This may be desired because carbide having relatively low cobalt content is more abrasion resistant than that having higher cobalt content. In addition, carbide with lower cobalt content is likely better to match the thermo-mechanical properties of PCD material, and so the internal stress generated by the bond between the PCD structure and the carrier body would be expected to be lower, resulting in more robust tools. Another aspect may be that PCD material comprising diamond grains having lower average size can be used without the need for pre-blending solvent/catalyst into the starting diamond powder.

In some examples, the carrier body may comprise cobalt-cemented tungsten carbide, in which the cobalt content is at least 1 weight percent and at most about 7 weight percent. In other examples, the cemented tungsten carbide may comprise at least about 9 weight percent cobalt.

In examples where the superhard structure(s) comprise or consist essentially of PCD material, a bonding agent comprise a solvent/catalyst for synthetic diamond, such as cobalt, may be provided between the superhard structure(s) and the carrier body. This may improve the bonding of the superhard structure(s) to the carrier body. The bonding agent may be in the form of a wafer, layer or film.

The method disclosed herein implicitly requires components of the superhard tip to undergo at least two treatments at ultra-high pressure, each at several GPa. This is because the polycrystalline superhard material used as raw material for superhard structure would have been sintered at an ultra-high pressure of at least about 5 GPa, and would be subjected to a ultra-high pressure of at least about 2 GPa again as part of the pre-compact assembly. Treatment at ultra-high pressure may be considered relatively costly and the skilled person may be disinclined to use more than one such treatment in the manufacture of a single tip. However, the disclosed method using a double ultra-high pressure treatment seems to have the aspect of providing strong bonding of the polycrystalline superhard structure to the carrier body. Due to the fact that the polycrystalline superhard structure is provided pre-sintered, shape deformation of the structure during the joining step at an ultra-high pressure may be reduced. Cracking of the polycrystalline superhard structure may be reduced.

The following clauses are offered as further descriptions of the method, superhard tips and machine tools:

1. A method for making a pre-form body for a superhard tip for a rotary machine tool, particularly but not exclusively for a twist drill, the method including contacting at least one sintered polycrystalline superhard structure to a carrier body comprising cemented carbide to form a pre-compact assembly, and subjecting the pre-compact assembly to a pressure and temperature at which the superhard material is thermodynamically stable to form a pre-form body.

2. The method of clause 1, including subjecting an aggregated plurality of superhard particles to a pressure of at least 5 GPa and a temperature of at least about 1,250 degrees centigrade in the presence of a binder material to provide a superhard body comprising polycrystalline superhard material, and processing the superhard body to provide the polycrystalline superhard structure.

3. The method of any one of the preceding clauses, including forming a recess into the carrier body or precursor body, the recess configured to accommodate the polycrystalline superhard structure; and inserting the polycrystalline superhard structure into the recess to form the pre-compact assembly.

4. The method of any one of the preceding clauses, in which the carrier body comprises cobalt-cemented tungsten carbide, the cobalt content being in the range from 1 weight percent to 7 weight percent of the cemented carbide material.

5. The method of any one of the preceding clauses, in which the superhard structure comprises polycrystalline diamond (PCD) material.

6. The method of any one of the preceding clauses, in which the superhard structure comprises thermally stable PCD material.

7. The method of any one of the preceding clauses, in which the superhard structure comprises PCD material comprising diamond grains having a mean size of at least about 0.1 micron and at most about 10 microns, and in which the interstitial mean-free-path is less than 0.6 microns and the standard deviation of the mean-free-path is less than 0.9 microns.

8. The method of any one of the preceding clauses, in which the superhard structure comprises PCD material having interstitial mean free path between adjacent diamond grains of least about 0.05 microns and at most about 1.5 microns; and the standard deviation of the mean free path is at least about 0.05 microns and at most about 1.5 microns.

9. The method of any one of the preceding clauses, including treating the polycrystalline superhard structure and/or the carrier body in an acid solution having a pH value of at least 1 and at most 3, or in an alkali solution having a pH of at least 10, or at least 13.

10. The method of any one of the preceding clauses, including configuring the carrier body to accommodate at least one superhard structure and at least one buttress member disposed adjacent the superhard structure and a surface of the carrier body, contacting the polycrystalline superhard structure to the carrier body, and disposing the buttress member between a surface of the superhard structure and a surface of the carrier body to form the pre-compact assembly.

11. The method of clause 10, the recess having an inclined surface and configured to accommodate the polycrystalline superhard structure and a buttress member; inserting the polycrystalline superhard structure and the buttress member into the recess to form a pre-compact assembly; the buttress member disposed between the polycrystalline superhard structure and the inclined side surface of the recess; the inclined side surface configured operable to deflect the buttress member laterally against the polycrystalline superhard structure responsive to a force applied longitudinally to the pre-compact assembly.

12.The method of clause 10 or clause 11, including providing a substantially non-reactive foil and placing the substantially non-reactive foil (for example, comprising alumina) between the buttress member and the surface of the superhard structure or the surface of the carrier body, or both and the surface of the superhard structure and the surface of the carrier body to form the pre-compact assembly; subjecting the pre-compact assembly to a pressure and temperature at which the superhard material is thermodynamically stable; and removing the buttress member.

13. A method for making a superhard tip for a rotary machine tool, the method including providing a pre-form body according to the method of any one on clauses 1 to 12, and processing the pre-form body to form a superhard tip.

14. The method of any one of the preceding clauses, including processing the pre-form body to expose a surface of the superhard structure, the surface defining a cutting edge and a rake face.

15. The method of any one of the preceding clauses, including processing the pre-form body to provide a flute.

16. A superhard tip for a twist drill, comprising a PCD structure joined to a cemented carbide carrier, the PCD structure comprising PCD material having an interstitial mean free path of at least about 0.05 microns and at most about 1.5 microns; the standard deviation of the mean free path is at least about 0.05 microns and at most about 1.5 microns.

17. A superhard tip for a twist drill, in which the superhard structure comprises PCD material comprising diamond grains having a mean size of at least about 0.1 micron and at most about 10 microns, and in which the interstitial mean-free-path is less than 0.6 microns and the standard deviation of the mean-free-path is less than 0.9 microns.

18. The superhard tip of clause 16 or clause 17, in which the carrier body comprises cemented tungsten carbide material comprising tungsten carbide grains and cobalt, the content of the cobalt being at most 7 weight percent of the cemented carbide material.

19. The superhard tip of clause 16 to clause 18, in which the content of diamond in the PCD material is at least 90 volume percent of the PCD material.

20. The method of any of clauses 1 to 15, or the superhard tip of any one of clauses 16 to 19, in which the superhard tip is for a twist drill or an end mill, for example a ball-nosed end mill.

21. A rotary machine tool, such as an twist drill or an end mill, comprising a superhard tip made according to the method of any one of clauses 1 to 15, or comprising the superhard tip of any one of clauses 16 to 19.

A non-limiting example is described in more detail below.

### EXAMPLE

A carrier body formed of cobalt-cemented tungsten carbide comprising 8 weight percent of Co and grains of tungsten carbide (WC) having a mean size of about 6 microns was provided. The carrier body had the general form of a rounded cone with a right cylindrical base, as illustrated by FIG. 3. The radius of curvature r of the apex of working end of the carrier body was about 2.25 mm, and the cone angle K was about 120 degrees. A generally z-shaped slotted recess was cut into the carrier body by means of electro-discharge machining (EDM), as illustrated in FIG. 2B.

A pair of pre-sintered PCD discs was provided. They had been pre-formed by sintering together diamond grains in the presence of cobalt at a pressure of about 5.5 GPa and a temperature of about 1,300 degrees centigrade. The PCD comprised about 90 volume percent diamond grains and the about 10 volume percent cobalt, the diamond grains having a mean particle size of about 6 microns. The PCD discs were cut by means of EDM to the shapes schematically illustrated in FIG. 2B to form a pair of shaped PCD structures for insertion into the recess formed into the carrier body.

The PCD structures and the carrier body were immersed in a diluted solution of nitric acid having a pH value in the range 1 to 3 contained in glass flasks, which were placed in an ultrasonic bath for 20 to 30 minutes at ambient temperature. The cobalt cement material in the cemented carbide carrier body was not substantially dissolved by this treatment. Thereafter, the PCD structures and the carrier body were washed in ethanol and dried.

The PCD structures were inserted into the recess to form a pre-compact, which was subjected to a pressure of about 5.5 GPa and a temperature of about 1,450 degrees centigrade to form an integrally sintered drill tip pre-form.

The sintered drill tip pre-form can be described as comprising a PCD vein integrally bonded within a cemented carbide carrier body, and had the following observed characteristics:
although the two PCD structures had sintered together well to form an integrated vein, an interface between them was observable as a fine line;
the interface between the PCD vein and the carbide carrier body comprised a region rich in cobalt that had infiltrated from the carrier body and possibly also from the PCD structures during the sintering step. Carbide particles were evident within the cobalt-rich interface region;
the quality of the sintering of the PCD material appeared to have been improved by the sintering step, which was in effect a second ultra-high pressure sintering step to which the PCD structures had been subjected.

Various example embodiments of pick tools and methods for assembling and connecting them have been described above. Those skilled in the art will understand that changes and modifications may be made to those examples without departing from the spirit and scope of the claimed invention.

1. A method for making a pre-form body for a superhard tip for a rotary machine tool, the method including contacting at least one sintered polycrystalline superhard structure to a carrier body comprising cemented carbide to form a pre-compact assembly, and subjecting the pre-compact assembly to a pressure and temperature at which the superhard material is thermodynamically stable to form a pre-form body.

2. A method as claimed in claim 1, in which the rotary machine tool is a twist drill.

3. A method as claimed in claim 2, including forming a recess into the carrier body, the recess configured to accommodate the polycrystalline superhard structure; and inserting the polycrystalline superhard structure into the recess to form the pre-compact assembly.

4. A method as claimed in claim 1, in which the carrier body comprises cobalt-cemented tungsten carbide, the cobalt content being in the range from 1 weight percent to 7 weight percent.

5. A method as claimed in claim 2, in which the superhard structure comprises polycrystalline diamond (PCD) material.

6. A method as claimed in claim 5, in which the superhard structure comprises thermally stable PCD material.

7. A method as claimed in claim 2, in which the superhard structure comprises PCD material comprising diamond grains having a mean size of at least about 0.1 micron and at most about 10 microns, and in which the interstitial mean-free-path is less than 0.6 microns and the standard deviation of the mean-free-path is less than 0.9 microns.

8. A method as claimed in claim 5, in which the interstitial mean free path between adjacent diamond grains comprised in the PCD material, is least about 0.05 microns and at most about 1.5 microns; and the standard deviation of the mean free path is at least about 0.05 microns and at most about 1.5 microns.

9. A method as claimed in claim 1, including treating the polycrystalline superhard structure in an acid solution having a pH value of at least 1 and at most 3, or in an alkali solution having a pH of at least 10.

10. A method as claimed in claim 1, including configuring the carrier body to accommodate at least one superhard structure and at least one buttress member disposed adjacent the superhard structure and a surface of the carrier body, contacting the polycrystalline superhard structure to the carrier body, and disposing the buttress member between a surface of the superhard structure and a surface of the carrier body to form the pre-compact assembly.

11. A method as claimed in claim 10, the recess having an inclined surface and configured to accommodate the polycrystalline superhard structure and a buttress member; inserting the polycrystalline superhard structure and the buttress member into the recess to form a pre-compact assembly; the buttress member disposed between the polycrystalline superhard structure and the inclined side surface of the recess; the inclined side surface configured operable to deflect the buttress member laterally against the polycrystalline superhard structure responsive to a force applied longitudinally to the pre-compact assembly.

12. A method as claimed in claim 10, including providing a substantially non-reactive foil and placing the substantially non-reactive foil between the buttress member and the surface of the superhard structure or the surface of the carrier body, or both and the surface of the superhard structure and the surface of the carrier body to form the pre-compact assembly; subjecting the pre-compact assembly to a pressure and temperature at which the superhard material is thermodynamically stable; and removing the buttress member.

13. A method for making a superhard tip for a rotary machine tool, the method including contacting at least one sintered polycrystalline superhard structure to a carrier body comprising cemented carbide to form a pre-compact assembly, and subjecting the pre-compact assembly to a pressure and temperature at which the superhard material is thermodynamically stable to form a pre-form body, and processing the pre-form body to form a superhard tip.

14. A method as claimed in claim 13, including processing the pre-form body to expose a surface of the superhard structure, the surface defining a cutting edge and a rake face.

15. A method as claimed in claim 13, including processing the pre-form body to provide a flute.

16. A superhard tip for a twist drill, comprising a PCD structure joined to a cemented carbide carrier, the PCD structure comprising PCD material having an interstitial mean free path of at least about 0.05 microns and at most about 1.5 microns; the standard deviation of the mean free path is at least about 0.05 microns and at most about 1.5 microns.

17. A superhard tip for a twist drill, in which the superhard structure comprises PCD material comprising diamond grains having a mean size of at least about 0.1 micron and at most about 10 microns, and in which the interstitial mean-free-path is less than 0.6 microns and the standard deviation of the mean-free-path is less than 0.9 microns.

18. A superhard tip as claimed in claim 17, in which the carrier body comprises cemented tungsten carbide material comprising tungsten carbide grains and cobalt, the content of the cobalt being at most 7 weight percent of the cemented carbide material.

19. A superhard tip as claimed in claim 17, in which the content of diamond in the PCD material is at least 90 volume percent of the PCD material.

20. A rotary machine tool comprising a superhard tip made by a method as claimed in claim 1.
